(19) United States
(12) Patent Application Publication
(10) Pub. No.: US 2022/0297251 A1
(43) Pub. Date: Sep. 22, 2022

(54) PROCESSING SYSTEM, AND METHOD FOR MANUFACTURING PROCESSED PRODUCT

(71) Applicant: Sumitomo Electric Sintered Alloy, Ltd., Takahashi-shi, Okayama (JP)

(72) Inventor: Masaki UNTEN, Takahashi-shi, Okayama (JP)

(73) Assignee: Sumitomo Electric Sintered Alloy, Ltd., Takahashi-shi, Okayama (JP)

(21) Appl. No.: 17/639,581

(22) PCT Filed: Aug. 31, 2020
(86) PCT No.: PCT/JP2020/032921

§ 371 Date: Mar. 2, 2022

(30) Foreign Application Priority Data
Sep. 6, 2019 (JP) 2019-163219

(51) Int. Cl. B23Q 17/09; B23Q 17/10; B23Q 15/08

(52) U.S. Cl. CPC B23Q 17/0961; B23Q 17/0995; B23Q 17/10; B23Q 15/08

(57) ABSTRACT

A processing system that successively processes a plurality of workpieces includes: a tool that processes each of the workpieces; a motor that rotates the tool or each of the workpieces; a control unit that controls the motor; and a measurement unit that obtains an electrical quantity of the motor, where the control unit includes a first control unit that controls a rotational speed of the motor based on a first difference between a first electrical quantity and a second electrical quantity, the first electrical quantity is an electrical quantity obtained by the measurement unit at a specific processed portion of a first workpiece currently being processed, the second electrical quantity is an electrical quantity obtained by the measurement unit during processing of a portion of a second workpiece corresponding to the specific processed portion, and the second workpiece is a workpiece that was processed prior to the first workpiece.

### TECHNICAL FIELD

The present disclosure relates to a processing system, and a method for manufacturing a processed product.

The present application claims priority to Japanese Patent Application No. 2019-163219 filed on Sep. 6, 2019, the entire contents of which are incorporated herein by reference.

### BACKGROUND ART

PTL 1 discloses a technique of determining, when processing a workpiece, a variation from a waveform of an electrical parameter corresponding to a load of a motor mounted on a processing device, and detecting, based on the variation, an indication of chipping of a tool before the chipping occurs. This technique measures whether or not the variation exceeds a preset threshold value.

### CITATION LIST

### Patent Literature

PTL 1: Japanese Patent Laying-Open No. 2016-87781

### SUMMARY OF INVENTION

A processing system of the present disclosure is

A processing system that successively processes a plurality of workpieces, the processing system comprising:

a tool that processes each of the workpieces;

a motor that rotates the tool or each of the workpieces;

a control unit that controls the motor; and

a measurement unit that obtains an electrical quantity of the motor, wherein

the control unit includes a first control unit that controls a rotational speed of the motor based on a first difference between a first electrical quantity and a second electrical quantity,

the first electrical quantity is an electrical quantity obtained by the measurement unit at a specific processed portion of a first workpiece currently being processed,

the second electrical quantity is an electrical quantity obtained by the measurement unit during processing of a portion of a second workpiece corresponding to the specific processed portion, and

the second workpiece is a workpiece that was processed prior to the first workpiece.

A method for manufacturing a processed product of the present disclosure is

A method for manufacturing a processed product, in which a plurality of workpieces are successively processed with a tool, the method comprising:

processing each of the workpieces while rotating the tool or each of the workpieces by a motor, and while measuring an electrical quantity of the motor by a measurement unit;

obtaining a first difference between a first electrical quantity and a second electrical quantity; and

controlling a rotational speed of the motor based on the first difference, wherein the first electrical quantity is an electrical quantity obtained by the measurement unit at a specific processed portion of a first workpiece currently being processed,

the second electrical quantity is an electrical quantity obtained by the measurement unit during processing of a portion of a second workpiece corresponding to the specific processed portion, and

the second workpiece is a workpiece that was processed prior to the first workpiece.

### BRIEF DESCRIPTION OF DRAWINGS

FIG. 1 is an illustrative diagram showing a processing system of an embodiment.

FIG. 2 is a flowchart showing a procedure of a first control unit in the processing system of the embodiment.

FIG. 3 is a flowchart showing a procedure of a second control unit in the processing system of the embodiment.

FIG. 4 is a graph showing an example where fracture of a tool was detected from waveforms each indicating a temporal change in a load current of a motor obtained by the processing system of the embodiment.

FIG. 5 is a graph showing an example where fracture of the tool was detected from waveforms each indicating a spectrum obtained by Fourier transform of the load current of the motor obtained by the processing system of the embodiment.

FIG. 6 is a graph showing an example where chipping of a tool was detected from waveforms each indicating a temporal change in a load current of a motor obtained by the processing system of the embodiment.

FIG. 7 is a graph showing an example where chipping of the tool was detected from waveforms each indicating a spectrum obtained by Fourier transform of the load current of the motor obtained by the processing system of the embodiment.

FIG. 8 is an illustrative diagram showing a variation of the processing system of the embodiment.

### DETAILED DESCRIPTION

### Problem to be Solved by the Present Disclosure

Chipping, fracture and the like are phenomena that may occur in a tool. The chipping refers to the occurrence of small cracking at an edge portion of a tool. The occurrence of chipping at the edge portion causes an increase in processing resistance, and an increase in the variation described above. By comparing the variation with a threshold value, therefore, the occurrence of chipping can be detected. Fracture, on the other hand, refers to the occurrence of large cracking at the edge portion. The occurrence of fracture at the edge portion makes processing itself difficult. Thus, the occurrence of fracture at the edge portion does not cause or causes only a slight increase if the variation increases. Therefore, there is a risk that fracture of a tool will not be detected if a preset certain threshold value is used as a reference, as in the technique described in PTL 1.

In addition, a load of a motor may change over the course of processing even a single workpiece. When a load of a motor changes, there is a risk that chipping will not be accurately detected if a preset certain threshold value is used as a reference.

One object of the present disclosure is to provide a processing system capable of accurately detecting chipping or fracture of a tool. Another object of the present disclosure is to provide a method for manufacturing a processed product capable of accurately detecting chipping or fracture of a tool.

### Advantageous Effect of the Present Disclosure

A processing system of the present disclosure can accurately detect chipping or fracture of a tool. A method for manufacturing a processed product of the present disclosure can accurately detect chipping or fracture of a tool.

### Description of Embodiment of the Present Disclosure

First, an embodiment of the present disclosure will be listed and described.

(1) A processing system according to the present disclosure is

A processing system that successively processes a plurality of workpieces, the processing system comprising:

a tool that processes each of the workpieces;

a motor that rotates the tool or each of the workpieces;

a control unit that controls the motor; and

a measurement unit that obtains an electrical quantity of the motor, wherein the control unit includes a first control unit that controls a rotational speed of the motor based on a first difference between a first electrical quantity and a second electrical quantity,

the first electrical quantity is an electrical quantity obtained by the measurement unit at a specific processed portion of a first workpiece currently being processed,

the second electrical quantity is an electrical quantity obtained by the measurement unit during processing of a portion of a second workpiece corresponding to the specific processed portion, and

the second workpiece is a workpiece that was processed prior to the first workpiece.

The processing system of the present disclosure can detect chipping or fracture of the tool based on the first difference between the first electrical quantity and the second electrical quantity. The second electrical quantity is an electrical quantity obtained during processing with a tool free from chipping or fracture. By obtaining the first difference using the second electrical quantity, therefore, the presence or absence of chipping or fracture that may occur in the tool is determined. Specifically, when the first difference is below a prescribed threshold value, it is determined that chipping or fracture has not occurred in the tool. When the first difference is higher than or equal to the prescribed threshold value, on the other hand, it is determined that chipping or fracture has occurred in the tool.

When chipping or fracture occurs in the tool, a particular change occurs in the electrical quantity obtained by the measurement unit, as compared to when chipping or fracture has not occurred in the tool. When the electrical quantity is a load current of the motor, for example, a temporal change in the load current exhibits the following tendency depending on the presence or absence of chipping or fracture of the tool. When fracture occurs in the tool, an absolute value of the first electrical quantity becomes lower than an absolute value of the second electrical quantity. This is because when fracture occurs in the tool, an increased area of the tool no longer makes contact with the workpiece, resulting in difficulty of the processing itself. When chipping occurs in the tool, on the other hand, the absolute value of the first electrical quantity becomes higher than the absolute value of the second electrical quantity. This is because when chipping occurs in the tool, a chipped portion of the tool makes contact with the work, causing an increase in processing resistance. A portion of the tool where fracture or chipping occurs is often a cutting edge. The processing system of the present disclosure detects chipping or fracture of the tool based on the particular change in the electrical quantity which is the first difference between the first electrical quantity and the second electrical quantity. Therefore, the processing system of the present disclosure can accurately detect the occurrence of either fracture or chipping in the tool.

The electrical quantity obtained by the measurement unit may changeover the course of processing even a single workpiece. The first electrical quantity and the second electrical quantity are electrical quantities obtained during processing of the specific processed portions of the first workpiece and the second workpiece corresponding to each other. Thus, even if the aforementioned electrical quantity changes in a single workpiece, chipping or fracture that has occurred in the tool can be accurately detected because the electrical quantities at the specific portions corresponding to each other are compared.

(2) As an example of the processing system of the present disclosure,

the specific processed portion may be a portion where a processing condition of the tool changes.

Over the course of processing a single workpiece, at the portion where the processing condition of the tool changes, a particular change occurs in the electrical quantity obtained by the measurement unit. By focusing on the particular change, the specific processed portions of the first workpiece and the second workpiece corresponding to each other can be readily set. By focusing on the aforementioned particular change, therefore, chipping or fracture that has occurred in the tool can be more accurately detected. The portion where the processing condition of the tool changes will be described later in detail.

(3) As an example of the processing system of the present disclosure,

the electrical quantity may be a load current of the motor.

The motor increases in load current with an increase in load torque, and decreases in load current with a decrease in load torque. The load torque is a torque required for resistance that occurs in the motor. By determining change in this load torque, processing resistance of the tool can be determined, and chipping or fracture that has occurred in the tool can be detected. The load torque is correlated with the load current, as described above. By measuring the load current of the motor and determining change in the current, therefore, change in the load torque can be determined, and chipping or fracture that has occurred in the tool can be efficiently detected.

(4) As an example of the processing system of the present disclosure,

when the first difference is higher than or equal to a prescribed threshold value, the first control unit may set the rotational speed of the motor to zero.

When the first control unit sets the rotational speed of the motor to zero, the rotation of the tool or the workpiece is stopped. When the first difference is higher than or equal to the prescribed threshold value, chipping or fracture has occurred in the tool. When the first difference is higher than or equal to the prescribed threshold value, therefore, the setting of the rotational speed of the motor to zero can stop the manufacture of defective products that have not been appropriately processed.

(5) As an example of the processing system of the present disclosure,

the control unit may include a second control unit that controls the rotational speed of the motor based on a second difference between the first electrical quantity and a third electrical quantity,

the third electrical quantity may be an electrical quantity obtained by the measurement unit during processing of a portion of a third workpiece corresponding to the specific processed portion, and

the third workpiece may be a workpiece that was processed prior to the first workpiece with a new tool.

A tool deteriorates over time. Processing is still possible with a deteriorated tool, if chipping or fracture has not occurred. Depending on the degree of deterioration, however, processing accuracy may be adversely affected. Deterioration of a tool can be determined by an electrical quantity of a motor. The processing system of the present disclosure can detect the degree of deterioration of the tool based on the second difference between the first electrical quantity and the third electrical quantity. The third electrical quantity is an electrical quantity obtained during processing with a new tool. Thus, when the second difference is below the prescribed threshold value, it is determined that the deterioration of the tool is within an acceptable range. When the second difference is higher than or equal to the prescribed threshold value, on the other hand, it is determined that the tool is nearing the end of its life. Since the degree of deterioration of the tool can be determined by the second difference, the controlling of the rotational speed of the motor based on the second difference can suppress the adverse effect on the processing accuracy.

The deterioration of the tool occurs gradually over time. Thus, even if the electrical quantity changes due to the deterioration of the tool, the difference between the first electrical quantity and the second electrical quantity is small. Accordingly, in the first difference for use in the first control unit, the difference between the electrical quantities caused by the deterioration of the tool can be considered negligible. Therefore, the determination of whether or not chipping or fracture has occurred in the tool can be appropriately made based on the first difference.

(6) A method for manufacturing a processed product according to the present disclosure is

A method for manufacturing a processed product, in which a plurality of workpieces are successively processed with a tool, the method comprising:

processing each of the workpieces while rotating the tool or each of the workpieces by a motor, and while measuring an electrical quantity of the motor by a measurement unit;

obtaining a first difference between a first electrical quantity and a second electrical quantity; and

controlling a rotational speed of the motor based on the first difference, wherein

the first electrical quantity is an electrical quantity obtained by the measurement unit at a specific processed portion of a first workpiece currently being processed,

the second electrical quantity is an electrical quantity obtained by the measurement unit during processing of a portion of a second workpiece corresponding to the specific processed portion, and

the second workpiece is a workpiece that was processed prior to the first workpiece.

The method for manufacturing a processed product of the present disclosure can detect chipping or fracture of the tool based on the first difference between the first electrical quantity and the second electrical quantity. The second electrical quantity is an electrical quantity obtained during processing with a tool free from chipping or fracture. By obtaining the first difference using the second electrical quantity, therefore, the presence or absence of chipping or fracture that may occur in the tool is determined. Specifically, when the first difference is below a prescribed threshold value, it is determined that chipping or fracture has not occurred in the tool. When the first difference is higher than or equal to the prescribed threshold value, on the other hand, it is determined that chipping or fracture has occurred in the tool.

As described above, when chipping or fracture occurs in the tool, a particular change occurs in the electrical quantity obtained by the measurement unit, as compared to when chipping or fracture has not occurred in the tool. The method for manufacturing a processed product of the present disclosure detects chipping or fracture of the tool based on the first difference which is the particular change in the electrical quantity, and can therefore accurately detect the occurrence of either fracture or chipping in the tool.

As described above, the electrical quantity obtained by the measurement unit may change over the course of processing even a single workpiece. Even if the electrical quantity changes in a single workpiece, the method for manufacturing a processed product of the present disclosure can accurately detect chipping or fracture that has occurred in the tool, because the electrical quantities at the specific portions of the first workpiece and the second workpiece corresponding to each other are compared.

### Details of Embodiment of the Present Disclosure

The details of an embodiment of the present disclosure will now be described with reference to the drawings. It should be noted that the present invention is defined by the terms of the claims, rather than being limited to these examples, and is intended to include any modifications within the scope and meaning equivalent to the terms of the claims.

### SUMMARY

A processing system of an embodiment successively processes a plurality of workpieces. In the following description, of the plurality of workpieces successively processed by the processing system, a workpiece currently being processed is referred to as a first workpiece. In addition, a workpiece that was processed prior to and immediately before the first workpiece is referred to as a second workpiece. In addition, a workpiece that was processed prior to the first workpiece with a new tool is referred to as a third workpiece. The first workpiece, the second workpiece, and the third workpiece are processed with the same tool. One feature of the processing system of the embodiment is that chipping or fracture of the tool is detected based on a first difference between a first electrical quantity obtained during processing of the first workpiece and a second electrical quantity obtained during processing of the second workpiece. In the following, the processing system, and a method for manufacturing a processed product using the processing system will be described first, and specific examples where chipping and fracture of the tool were detected will be described thereafter.

<Processing System>

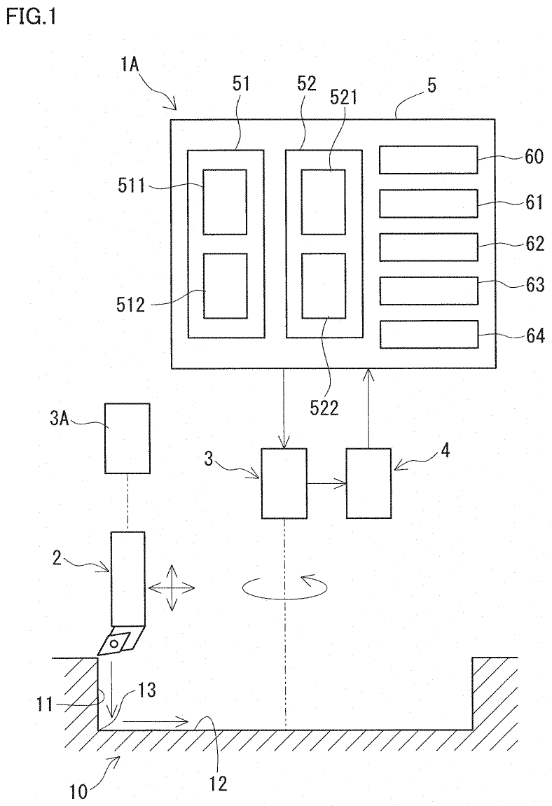

A processing system 1A includes a tool 2, a motor 3, a measurement unit 4, and a control unit 5, as shown in FIG. 1. Tool 2 processes a workpiece 10. Motor 3 rotates tool 2 or workpiece 10. Measurement unit 4 obtains an electrical quantity of motor 3. Control unit 5 controls motor 3. Control unit 5 includes a first control unit 51 that controls a rotational speed of motor 3 based on the first difference between the first electrical quantity and the second electrical quantity. Chipping or fracture that may occur in tool 2 can be detected by first control unit 51.

In processing system 1A of this example, control unit 5 further includes a second control unit 52 that controls the rotational speed of motor 3 based on a second difference between the first electrical quantity and a third electrical quantity. The third electrical quantity is an electrical quantity obtained during processing of the third workpiece. Wear of tool 2 due to age deterioration can be detected by second control unit 52 if the wear occurs.

<<Workpiece>>

The first workpiece, the second workpiece, and the third workpiece have the same shape. In the following, the simple mentioning of workpiece 10 is used when describing features common to each workpiece. The material, type, and shape of workpiece 10 are not particularly limited, and can be selected as appropriate. The material of workpiece 10 may typically be metal, resin, or ceramics. The metal may be pure iron, a ferrous alloy, or non-ferrous metal. The type of workpiece 10 may be, for example, a pressed powder body, a sintered material, or a cast material. Workpiece 10 of this example is a metallic sintered material.

Workpiece 10 of this example has a recess formed by a wall surface 11 and a bottom surface 12. Workpiece 10 is rotated by motor 3. In FIG. 1, a chain-double-dotted line connecting workpiece 10 and motor 3 indicates a virtual axis of rotation of workpiece 10 rotated by motor 3. Workpiece 10 rotates about this axis of rotation.

<<Tool>>

Tool 2 can be selected as appropriate depending of the type of processing. Tool 2 of this example is an indexable bite. Tool 2 is moved vertically and horizontally by a motor 3A, as indicated by arrows in FIG. 1. This example describes performing finishing, in workpiece 10 having the recess, on wall surface 11 and bottom surface 12 in the recess by tool 2. This example also describes turning in which workpiece 10 is rotated by motor 3, and tool 2 is applied to rotating workpiece 10 to perform the turning. With the rotation of workpiece 10 and the movement of tool 2, the finishing is performed on wall surface 11 and bottom surface 12 in the recess in workpiece 10.

<<Measurement Unit>>

Measurement unit 4 obtains an electrical quantity for use in driving motor 3. The electrical quantity may be a load current of motor 3. Measurement unit 4 may be a current sensor, for example. The load current of motor 3 is proportional to a load torque of motor 3. Motor 3 increases in load current with an increase in load torque, and decreases in load current with a decrease in load torque. The load torque is a torque required for resistance that occurs in motor 3. By determining change in the load torque of motor 3, therefore, processing resistance of tool 2 can be determined. By determining the processing resistance of tool 2, chipping or fracture and wear that may occur in tool 2 can be readily detected.

When the electrical quantity is the load current of motor 3, for example, a temporal change in the load current exhibits the following tendency depending on the presence or absence of chipping or fracture of tool 2. When chipping occurs in tool 2, a chipped portion of tool 2 makes contact with workpiece 10, causing an increase in the processing resistance. When chipping occurs in tool 2, therefore, the increased processing resistance of tool 2 causes an increase in the load torque of motor 3, and also an increase in the load current of motor 3. When fracture occurs in tool 2, an increased area of tool 2 no longer makes contact with workpiece 10, causing a decrease in the processing resistance. When fracture occurs in tool 2, therefore, the decreased processing resistance of tool 2 causes a decrease in the load torque of motor 3, and also a decrease in the load current of motor 3. It is seen from the above that chipping or fracture that has occurred in tool 2 can be efficiently detected by measuring the load current of motor 3. A portion of tool 2 where fracture or chipping occurs is often a cutting edge. Examples where chipping and fracture of tool 2 were detected based on change in the load current of motor 3 obtained by measurement unit 4, and the load current, will be described later in detail.

In addition, if the electrical quantity is the load current of motor 3, when tool 2 wears, a worn portion of tool 2 makes contact with workpiece 10, causing an increase in the processing resistance. When tool 2 wears, therefore, the increased processing resistance of tool 2 causes an increase in the load torque of motor 3, and also an increase in the load current of motor 3. However, a rate of increase in the processing resistance and a rate of increase in the load current of motor 3 due to the wear of tool 2 are significantly lower than a rate of increase in the processing resistance and a rate of increase in the load current of motor 3 due to the chipping of tool 2. Accordingly, wear that has occurred in tool 2 can also be efficiently detected, in addition to the chipping or fracture, by measuring the load current of motor 3.

<<Control Unit>>

Control unit 5 includes first control unit 51. First control unit 51 controls the rotational speed of motor 3 based on a result of detection of chipping or fracture that may occur in tool 2. Control unit 5 of this example further includes second control unit 52. Second control unit 52 controls the rotational speed of motor 3 based on a result of detection of wear that may occur in tool 2.

A computer can be utilized, for example, as control unit 5. The computer typically includes a processor and a memory. The processor is a CPU, for example. The memory stores a control program to be executed by the processor, and various types of data. Control unit 5 is operated by execution of the control program stored in the memory by the processor.

[First Control Unit]

First control unit 51 includes a first calculation unit 511 and a first comparison unit 512. It can be determined by first calculation unit 511 and first comparison unit 512 whether or not chipping or fracture has occurred in tool 2. First control unit 51 controls the rotational speed of the motor based on the first difference obtained by first calculation unit 511 and first comparison unit 512.

When the first difference is higher than or equal to a first threshold value, first control unit 51 instructs motor 3 to decrease the rotational speed of motor 3. For example, when the first difference is higher than or equal to the first threshold value in first comparison unit 512, first control unit 51 sets the rotational speed of motor 3 to zero, that is, stops the driving of motor 3. Once the driving of motor 3 is stopped, tool 2 in which the chipping or fracture has occurred is replaced by a new tool.

When the first difference is below the first threshold value, on the other hand, first control unit 51 does not provide an instruction to decrease the rotational speed of motor 3. Then, a plurality of workpieces are successively processed, and the process of first control unit 51 is repeated for each workpiece being processed.

First calculation unit 511 and first comparison unit 512 will now be described in detail.

(First Calculation Unit)

First calculation unit 511 calculates the first difference between the first electrical quantity and the second electrical quantity. The first electrical quantity is an electrical quantity obtained by measurement unit 4 at a specific processed portion of the first workpiece. The second electrical quantity is an electrical quantity obtained by measurement unit 4 during processing of a portion of the second workpiece corresponding to the aforementioned specific processed portion. The second electrical quantity is an electrical quantity obtained during processing with tool 2 free from chipping or fracture. It should be noted that the electrical quantity obtained by measurement unit 4 includes not merely a measured value itself, but also a calculated value derived from the measured value. The calculated value may be a value obtained by Fourier transform of the measured value, as will be described later.

The second electrical quantity is stored in a third memory 63. The first electrical quantity is stored in a temporary memory 60. As soon as the first electrical quantity is stored in temporary memory 60, first calculation unit 511 calculates the first difference between the first electrical quantity and the second electrical quantity. In other words, first calculation unit 511 calculates the first difference in parallel with the processing of the first workpiece.

The second electrical quantity preferably includes an electrical quantity obtained during processing of the second workpiece immediately before the first workpiece. For example, the second electrical quantity may be an electrical quantity obtained during processing of the second workpiece immediately before the first workpiece. Alternatively, the second electrical quantity may be an average value of electrical quantities obtained during processing of a plurality of second workpieces that were processed even prior to the second workpiece immediately before the first workpiece. When the average value of the electrical quantities of the plurality of second workpieces is used, an average value of electrical quantities of successive second workpieces including the workpiece immediately before the first workpiece may be used. The plurality of second workpieces may be two or more and ten or less workpieces.

When processing a workpiece for the first time, the first difference is calculated using a premeasured reference electrical quantity. The reference electrical quantity is an electrical quantity obtained during processing of a portion of workpiece 10 corresponding to a specific processed portion with a tool free from chipping and fracture.

The electrical quantity obtained by measurement unit 4 may change over the course of processing even a single workpiece 10. Of the electrical quantities obtained by measurement unit 4, the first electrical quantity and the second electrical quantity are electrical quantities that are used for comparison with each other. Therefore, electrical quantities obtained during processing of specific processed portions of the first workpiece and the second workpiece corresponding to each other are used as the first electrical quantity and the second electrical quantity. The aforementioned specific processed portions are not particularly limited, so long as they are portions of the first workpiece and the second workpiece corresponding to each other.

The aforementioned specific processed portion is preferably a prescribed area of workpiece 10 that is successively processed by tool 2. For example, in workpiece 10 having the recess, an edge portion of tool 2 may act only on wall surface 11, or may act only on bottom surface 12, or may simultaneously act both on wall surface 11 and bottom surface 12. The reason that the edge portion of tool 2 simultaneously acts both on wall surface 11 and bottom surface 12 is to process a corner 13 formed by wall surface 11 and bottom surface 12. The aforementioned specific processed portion may be an area forming wall surface 11, an area forming bottom surface 12, or an area forming corner 13.

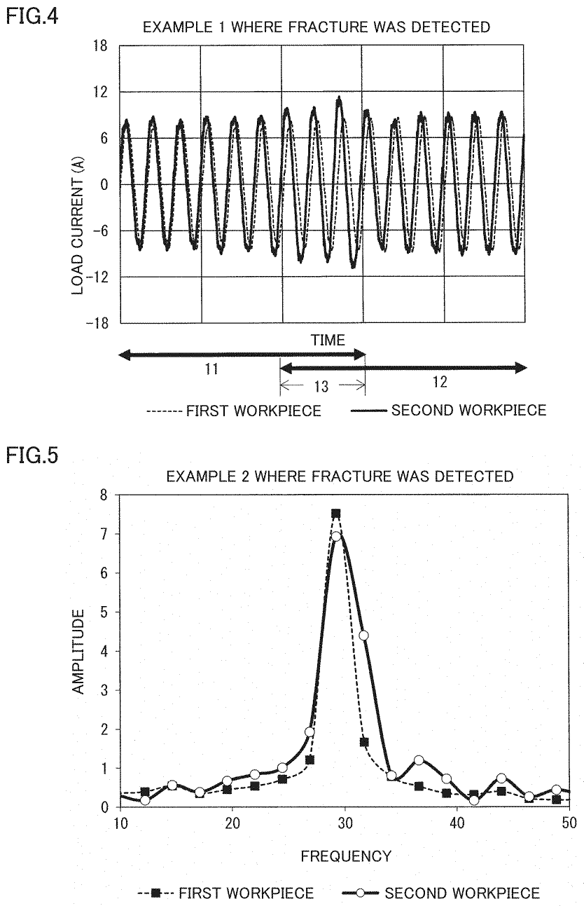

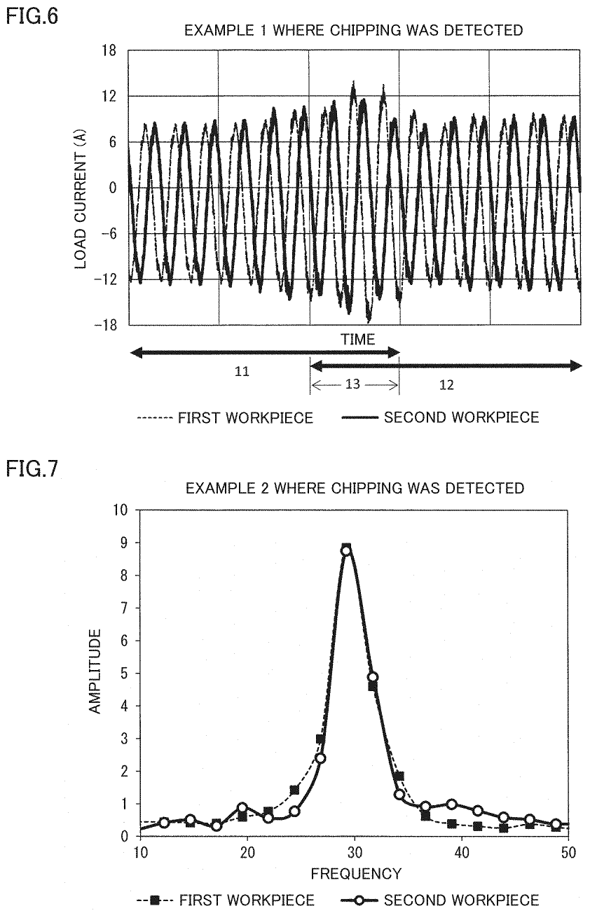

In particular, the aforementioned specific processed portion is preferably a portion where a processing condition of tool 2 changes. The processing condition of tool 2 may be a feed, a depth of cut of the edge portion of tool 2, a rotational speed, a feed direction, a processing time of tool 2 or workpiece 10, and the like. For example, in workpiece 10 having the recess, the aforementioned specific processed portion is preferably the area forming corner 13. When processing corner 13, the edge portion of tool 2 changes in the feed direction from wall surface 11 toward bottom surface 12. Such a change in the feed direction causes a change in a portion of the edge portion of tool 2 that comes into contact with workpiece 10. Specifically, when processing corner 13, the edge portion of tool 2 simultaneously acts both on wall surface 11 and bottom surface 12. The processing resistance of tool 2 thereby increases in the area forming corner 13. When the electrical quantity obtained by measurement unit 4 is the load current of motor 3, for example, the load current has a waveform that increases at corner 13 as compared to at wall surface 11 and bottom surface 12, as shown in FIGS. 4 and 6. A way to look at the graphs shown in FIGS. 4 and 6 will be described later.

As described above, over the course of processing a single workpiece 10, at the portion where the processing condition of tool 2 changes, a particular change occurs in the electrical quantity obtained by measurement unit 4. By focusing on the particular change, the specific processed portions of the first workpiece and the second workpiece corresponding to each other can be readily set. In addition, in workpiece 10 having the recess, when processing corner 13, the edge portion of tool 2 simultaneously acts both on wall surface 11 and bottom surface 12 as described above. In this case, tool 2 has an increased area of contact with workpiece 10, causing an increase in the processing resistance of tool 2, and also an increase in change in the electrical quantity obtained by measurement unit 4. Accordingly, the change in the electrical quantity caused by chipping or fracture that has occurred in tool 2 can be relatively readily detected, and the chipping or fracture that has occurred in tool 2 can be more accurately detected. In workpiece 10 having the recess, the aforementioned specific processed portion preferably includes, in addition to the area forming corner 13, the area forming wall surface 11 and the area forming bottom surface 12. The particular change that occurs in the area forming corner 13 can thereby be more readily identified.

(First Comparison Unit)

First comparison unit 512 compares the first difference obtained by first calculation unit 511 with the first threshold value. The first threshold value is a preset value. The first threshold value can be determined as follows, for example. First, the portion of workpiece 10 corresponding to the specific processed portion is processed with a tool free from chipping and fracture, and an electrical quantity is obtained by the measurement unit. In addition, the portion of workpiece 10 corresponding to the specific processed portion is processed with a tool in which chipping or fracture to be detected has occurred, and an electrical quantity is obtained by the measurement unit. A difference between these obtained electrical quantities is calculated, and a value thereof is set as the first threshold value. The first threshold value of this example is stored in a first memory 61. As soon as the first difference is calculated by first calculation unit 511, first comparison unit 512 compares the first difference with the first threshold value.

When the first difference is below the first threshold value, first comparison unit 512 determines that chipping or fracture has not occurred in tool 2. In this case, the first electrical quantity stored in temporary memory 60 is overwritten into third memory 63. In other words, when it is determined in first comparison unit 512 that chipping or fracture has not occurred in tool 2, the first electrical quantity is used as the second electrical quantity which will be used for comparison in a workpiece that is processed after the first workpiece. When an average value of electrical quantities of a plurality of second workpieces is used as the second electrical quantity, an average value recalculated with the first electrical quantity stored in temporary memory 60 is overwritten into third memory 63. The overwriting into third memory 63 may be performed immediately after the comparison between the first difference and the first threshold value, or may be collectively performed after the processing of the first workpiece has been entirely completed. When the first difference is higher than or equal to the first threshold value, on the other hand, first comparison unit 512 determines that chipping or fracture has occurred in tool 2.

(Procedure of Detecting Chipping or Fracture)

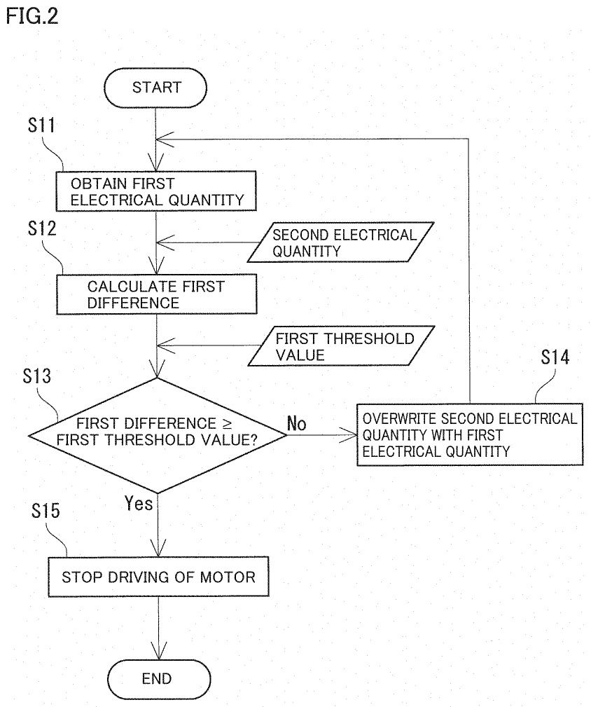

Referring to FIG. 2, a procedure of detecting chipping or fracture of tool 2 by first control unit 51 is described.

In step S11, the first electrical quantity measured by measurement unit 4 at the specific processed portion of the first workpiece is obtained.

In step S12, the first difference between the first electrical quantity and the second electrical quantity is calculated by first calculation unit 511. The second electrical quantity is read from third memory 63.

In step S13, the first difference and the first threshold value are compared by first comparison unit 512. The first threshold value is read from first memory 61.

When the first difference is below the first threshold value in step S13, the second electrical quantity is overwritten with the first electrical quantity in step S14 The overwritten second electrical quantity is stored in third memory 63. Step S11 through step S13 are subsequently repeated.

When the first difference is higher than or equal to the first threshold value in step S13, the rotational speed of motor 3 is set to zero, that is, the driving of motor 3 is stopped, in step S15.

A plurality of different threshold values can be set as the first threshold value. For example, an intermediate threshold value for detecting acceptable chipping or fracture, and a final threshold value for detecting unacceptable chipping or fracture can be set as the first threshold value. The setting of a plurality of threshold values allows for detection of chipping or fracture at multiple stages based on the amount of chipping or the amount of fracture. Accordingly, even if chipping or fracture has occurred in tool 2, it may be possible to perform the processing, although productivity is reduced due to the decreased rotational speed of motor 3.

For example, when the first threshold value includes the intermediate threshold value and the final threshold value described above, first control unit 51 performs the following control. The first threshold value is set to the intermediate threshold value. When the first difference is below the intermediate threshold value in first comparison unit 512, first control unit 51 does not provide an instruction to decrease the rotational speed of motor 3. Then, when successively processing a plurality of workpieces, the process of first control unit 51 is repeated for each workpiece being processed. When the first difference is higher than or equal to the intermediate threshold value in first comparison unit 512, first control unit 51 decreases the rotational speed of motor 3 without stopping the driving of motor 3. When the rotational speed of motor 3 is decreased, the value of first memory 61 is overwritten with the final threshold value as the first threshold value. After the rotational speed of motor 3 has been decreased, a plurality of workpieces are successively processed. Then, when the first difference is below the final threshold value in first comparison unit 512, first control unit 51 repeats the processing without providing an instruction to decrease the rotational speed of motor 3. When the first difference is higher than or equal to the final threshold value in first comparison unit 512, first control unit 51 sets the rotational speed of motor 3 to zero, that is, stops the driving of motor 3.

[Second Control Unit]

Second control unit 52 includes a second calculation unit 521 and a second comparison unit 522. It can be determined by second calculation unit 521 and second comparison unit 522 whether or not wear has occurred in tool 2. Second control unit 52 controls the rotational speed of motor 3 based on the second difference obtained by second calculation unit 521 and second comparison unit 522.

When the second difference is higher than or equal to a second threshold value, second control unit 52 instructs motor 3 to decrease the rotational speed of motor 3. For example, when the second difference is higher than or equal to the second threshold value in second comparison unit 522, second control unit 52 sets the rotational speed of motor 3 to zero, that is, stops the driving of motor 3. Once the driving of motor 3 is stopped, tool 2 in which the wear has occurred is replaced by a new tool.

When the second difference is below the second threshold value, on the other hand, second control unit 52 does not provide an instruction to decrease the rotational speed of motor 3. Then, a plurality of workpieces are successively processed, and the process of second control unit 52 is repeated for each workpiece being processed.

Second calculation unit 521 and second comparison unit 522 will now be described in detail.

(Second Calculation Unit)

Second calculation unit 521 calculates the second difference between the first electrical quantity and the third electrical quantity. The third electrical quantity is an electrical quantity obtained by measurement unit 4 during processing of a portion of the third workpiece corresponding to the aforementioned specific processed portion. The third electrical quantity is an electrical quantity obtained during processing with a new tool 2, which is an electrical quantity obtained during processing with a tool free from not merely chipping or fracture, but also wear. The third electrical quantity can be obtained when processing system 1A is started. The third electrical quantity is stored in a fourth memory 64. As soon as the first electrical quantity is stored in temporary memory 60, second calculation unit 521 calculates the second difference between the first electrical quantity and the third electrical quantity, in a manner similar to first calculation unit 511. In other words, second calculation unit 521 calculates the second difference in parallel with the processing of the first workpiece.

The third electrical quantity is a physical quantity obtained during processing of a small number of third workpieces with a new tool 2. For example, the third electrical quantity may be an electrical quantity obtained during processing of a third workpiece for the first time with an unused tool 2. Alternatively, the third electrical quantity may be an average value of electrical quantities obtained by successive processing of a plurality of third workpieces after the processing of a third workpiece for the first time with unused tool 2. The plurality of third workpieces may be two or more and ten or less workpieces. If the number of workpieces that have been processed is ten or less, the tool with which those workpieces have been processed can be considered a new tool.

As described above, over the course of processing a single workpiece 10, at the portion where the processing condition of tool 2 changes, a particular change occurs in the electrical quantity obtained by measurement unit 4. By focusing on the particular change, the specific processed portions of the first workpiece and the third workpiece corresponding to each other can be readily set. In addition, in workpiece 10 having the recess, when processing corner 13, the edge portion of tool 2 simultaneously acts both on wall surface 11 and bottom surface 12 as described above. In this case, tool 2 has an increased area of contact with workpiece 10, causing an increase in the processing resistance of tool 2, and also an increase in change in the electrical quantity obtained by measurement unit 4. Accordingly, the change in the electrical quantity caused by wear that has occurred in tool 2 can be relatively readily detected, and wear of tool 2 can be more accurately detected.

(Second Comparison Unit)

Second comparison unit 522 compares the second difference obtained by second calculation unit 521 with the second threshold value. The second threshold value is a preset value. The second threshold value can be determined as follows, for example. First, the portion of workpiece 10 corresponding to the specific processed portion is processed with a tool free from wear, and an electrical quantity is obtained by the measurement unit. In addition, the portion of workpiece 10 corresponding to the specific processed portion is processed with a tool having an amount of wear near the end of life of tool 2, and an electrical quantity is obtained by the measurement unit. A difference between these obtained electrical quantities is calculated, and a value thereof is set as the second threshold value. The second threshold value of this example is stored in a second memory 62. As soon as the second difference is calculated by second calculation unit 521, second comparison unit 522 compares the second difference with the second threshold value.

When the second difference is below the second threshold value, second comparison unit 522 determines that wear has not substantially occurred in tool 2, or that a small amount of wear has occurred that is associated with the use of tool 2 and within an acceptable range. When the second difference is higher than or equal to the second threshold value, on the other hand, second comparison unit 522 determines that wear near the end of its life has occurred in tool 2.

[Procedure of Detecting Wear]

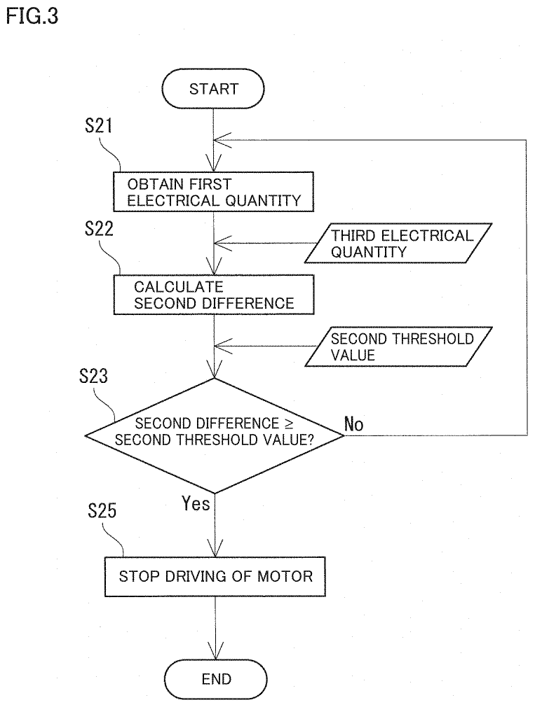

Referring to FIG. 3, a procedure of detecting wear of tool 2 by second control unit 52 is described.

In step S21, the first electrical quantity measured by measurement unit 4 at the specific processed portion of the first workpiece is obtained.

In step S22, the second difference between the first electrical quantity and the third electrical quantity is calculated by second calculation unit 521. The third electrical quantity is read from fourth memory 64.

In step S23, the second difference and the second threshold value are compared by second comparison unit 522. The second threshold value is read from second memory 62.

When the second difference is below the second threshold value in step S23, step S21 through step S23 are repeated.

When the second difference is higher than or equal to the second threshold value in step S23, the rotational speed of motor 3 is set to zero, that is, the driving of motor 3 is stopped, in step S25.

A plurality of different threshold values can be set as the second threshold value. For example, an intermediate threshold value for detecting acceptable wear, and a final threshold value for detecting unacceptable wear can be set as the second threshold value. The setting of a plurality of threshold values allows for detection of wear at multiple stages based on the amount of wear. Accordingly, even if wear has occurred in tool 2, it may be possible to perform the processing, although productivity is reduced due to the decreased rotational speed of motor 3.

For example, when the second threshold value includes the intermediate threshold value and the final threshold value described above, second control unit 52 performs the following control. The second threshold value is set to the intermediate threshold value. When the second difference is below the intermediate threshold value in second comparison unit 522, second control unit 52 does not provide an instruction to decrease the rotational speed of motor 3. Then, when successively processing a plurality of workpieces, the process of second control unit 52 is repeated for each workpiece being processed. When the second difference is higher than or equal to the intermediate threshold value in second comparison unit 522, second control unit 52 decreases the rotational speed of motor 3 without stopping the driving of motor 3. When the rotational speed of motor 3 is decreased, overwriting is performed with the final threshold value as the second threshold value. After the rotational speed of motor 3 has been decreased, a plurality of workpieces are successively processed.

Then, when the second difference is below the final threshold value in second comparison unit 522, second control unit 52 repeats the processing without providing an instruction to decrease the rotational speed of motor 3. When the second difference is higher than or equal to the final threshold value in second comparison unit 522, second control unit 52 sets the rotational speed of motor 3 to zero, that is, stops the driving of motor 3.

If control unit 5 includes second control unit 52, the rotational speed of motor 3 is controlled when the first difference is higher than or equal to the first threshold value, even when the second difference is below the second threshold value. When the first difference is higher than or equal to the first threshold value, it is preferred to set the rotational speed of motor 3 to zero, that is, to stop the driving of motor 3.

In addition, if control unit 5 includes second control unit 52, the rotational speed of motor 3 is controlled when the second difference is higher than or equal to the second threshold value, even when the first difference is below the first threshold value. The second control unit performs control when tool 2 wears due to age deterioration. When the second difference is higher than or equal to the second threshold value, therefore, the second control unit may decrease the rotational speed of motor 3 without stopping the driving of motor 3.

<Method for Manufacturing Processed Product>

A method for manufacturing a processed product of an embodiment includes the following steps:

Step A: Processing a workpiece;

Step B: Obtaining a first difference between a first electrical quantity and a second electrical quantity; and

Step C: Controlling a rotational speed of a motor based on the first difference.

Each step will now be described in detail.

<<Step A: Processing>>

In the processing step, a workpiece is processed while a tool or the workpiece is rotated by a motor, and while an electrical quantity for use in driving the motor is measured by a measurement unit. The electrical quantity for use in driving the motor may be a load current of the motor.

<<Step B: Obtaining First Difference>>

In the step of obtaining a first difference, a first difference between a first electrical quantity and a second electrical quantity is obtained. The first electrical quantity is an electrical quantity obtained by the measurement unit at a specific processed portion of a first work-piece. The second electrical quantity is an electrical quantity obtained by the measurement unit during processing of a portion of a second workpiece corresponding to the aforementioned specific processed portion. The step of obtaining the first difference is performed in parallel with processing of the first workpiece.

Step C: Controlling Rotational Speed of Motor

In the step of controlling a rotational speed of a motor, a rotational speed of the motor is controlled based on the first difference. Specifically, the first difference and a first threshold value are compared, and the rotational speed of the motor is decreased based on a result of the comparison. The first threshold value is a value for determining whether or not the tool has chipping or fracture. When the first difference is higher than or equal to the first threshold value, it can be determined that chipping or fracture has occurred in the tool. When the first difference is higher than or equal to the first threshold value, the rotational speed of the motor is decreased. For example, when the first difference is higher than or equal to the first threshold value, the rotational speed of the motor is set to zero, that is, the driving of the motor is stopped. Once the driving of the motor is stopped, the tool in which the chipping or fracture has occurred is replaced by a new tool. When the first difference is below the first threshold value, on the other hand, it can be determined that chipping or fracture has not occurred in the tool. When the first difference is below the first threshold value, a plurality of workpieces are successively processed without a change in the rotational speed of the motor. Then, step A through step C are repeated for each successively processed workpiece.

In addition, when the first difference is higher than or equal to the first threshold value, the rotational speed of motor 3 may be decreased without stopping of the driving of the motor. Even if chipping or fracture has occurred in the tool, it may be possible to perform the processing, although productivity is reduced due to the decreased rotational speed of the motor. In this case, after the rotational speed of the motor has been decreased, a plurality of workpieces are successively processed.

The comparison between the first difference and the first threshold value is performed as soon as the first difference is obtained. Accordingly, if chipping or fracture has occurred in the tool, the chipping or fracture can be detected in substantially real time during the processing of the first workpiece.

<<Additional Aspects>>

The method for manufacturing a processed product may further include the following steps:

Step D: Obtaining a second difference between the first electrical quantity and a third electrical quantity; and

Step E: Controlling the rotational speed of the motor based on the second difference.

Each step will now be described in detail.

<<Step D: Obtaining Second Difference>>

in the step of obtaining a second difference, a second difference between the first electrical quantity and a third electrical quantity is obtained. The third electrical quantity is an electrical quantity obtained by the measurement unit during processing of a portion of a third work-piece corresponding to the aforementioned specific processed portion with a new tool. The step of obtaining the second difference is performed in parallel with processing of the first workpiece.

<<Step E: Controlling Rotational Speed of Motor>>

In the step of controlling the rotational speed of the motor, the rotational speed of the motor is controlled based on the second difference. Specifically, the second difference and a second threshold value are compared, and the rotational speed of the motor is decreased based on a result of the comparison. The second threshold value is a value for determining whether or not wear has occurred in the tool. When the second difference is higher than or equal to the second threshold value, it can be determined that wear near the end of its life has occurred in the tool. When the second difference is higher than or equal to the second threshold value, the rotational speed of the motor is decreased. For example, when the second difference is higher than or equal to the second threshold value, the rotational speed of the motor is set to zero, that is, the driving of the motor is stopped. Once the driving of the motor is stopped, the tool in which the wear has occurred is replaced by a new tool. When the second difference is below the second threshold value, on the other hand, it can be determined that any wear that has occurred in the tool due to age deterioration is within an acceptable range. When the second difference is below the second threshold value, a plurality of workpieces are successively processed without a change in the rotational speed of the motor. Then, step D and step E are repeated, in addition to step A through step C, for each successively processed workpiece.

In addition, when the second difference is higher than or equal to the second threshold value, the rotational speed of the motor may be decreased without stopping of the driving of the motor. Even if wear has occurred in the tool, it may be possible to perform the processing, although productivity is reduced due to the decreased rotational speed of the motor. In this case, after the rotational speed of the motor has been decreased, a plurality of workpieces are successively processed.

The comparison between the second difference and the second threshold value is performed as soon as the second difference is obtained. Accordingly, if wear beyond the acceptable range has occurred in the tool, the wear can be detected in substantially real time during the processing of the first workpiece.

If step D and step E are included, the rotational speed of the motor is controlled when the first difference is higher than or equal to the first threshold value, even when the second difference is below the second threshold value. When the first difference is higher than or equal to the first threshold value, it is preferred to set the rotational speed of the motor to zero, that is, to stop the driving of the motor.

In addition, if step D and step E are included, the rotational speed of the motor is controlled when the second difference is higher than or equal to the second threshold value, even when the first difference is below the first threshold value. Step D and step E are steps that are performed when the tool wears due to age deterioration.

When the second difference is higher than or equal to the second threshold value, therefore, the rotational speed of the motor may be decreased without stopping of the driving of the motor.

Step D and step E may be performed instead of step B and step C in the method for manufacturing a processed product. In other words, step A, step D. and step E may be successively performed in the method for manufacturing a processed product.

˜Specific Examples Where Chipping and Fracture of Tool were Detected>

Specific examples where chipping and fracture that had occurred in tool 2 were detected during successive processing of a plurality of workpieces 10 by aforementioned processing system 1A will now be described. These examples describe detecting chipping and fracture that have occurred in tool 2 over the course of performing, in workpiece 10 having the recess as shown in FIG. 1, finishing on wall surface 11 and bottom surface 12 in the recess by tool 2. In the following, an example where fracture that had occurred in tool 2 was detected will be described first with reference to FIGS. 4 and 5, and an example where chipping that had occurred in tool 2 was detected will be described thereafter with reference to FIGS. 6 and 7.

In FIGS. 4 to 7, a waveform related to the second electrical quantity obtained by measurement unit 4 during processing of the second workpiece is indicated by a solid line, and a waveform related to the first electrical quantity obtained by measurement unit 4 during processing of the first workpiece is indicated by a dashed line. FIGS. 4 and 6 each show an example where the load current of motor 3 was measured as the electrical quantity of motor 3. The first electrical quantity obtained by measurement unit 4 during processing of the first workpiece is hereinafter referred to as a first load current. The second electrical quantity obtained by measurement unit 4 during processing of the second workpiece is hereinafter referred to as a second load current. In FIGS. 4 and 6, a horizontal axis represents time, and a vertical axis represents the load current. In addition, in FIGS. 4 and 6, a region where wall surface 11 is processed and a region where bottom surface 12 is processed are denoted by respective arrows along the horizontal axis. A region where the arrows overlap is a region where corner 13 is processed. In the region where corner 13 is processed, the edge portion of tool 2 simultaneously acts both on wall surface 11 and bottom surface 12. FIG. 5 shows an example obtained by Fourier transform of the graph shown in FIG. 4. FIG. 7 shows an example obtained by Fourier transform of the graph shown in FIG. 6. In FIGS. 5 and 7, therefore, a horizontal axis represents frequency, and a vertical axis represents amplitude.

<<Example where Fracture was Detected>>

When performing finishing on wall surface 11 and bottom surface 12 in the recess by tool 2, as in this example, the processing resistance during processing of corner 13 becomes higher than the processing resistance during processing of only wall surface 11 or only bottom surface 12. This is because, in the region where corner 13 is processed, the edge portion of tool 2 simultaneously acts both on wall surface 11 and bottom surface 12. Thus, the waveform related to the second load current obtained when chipping or fracture has not occurred in tool 2 is such that, as indicated by the solid line in FIG. 4, an absolute value of the load current of motor 3 during processing of corner 13 is higher by a prescribed amount than an absolute value of the load current of motor 3 during processing of only wall surface 11 or only bottom surface 12. By focusing on the waveform at corner 13, therefore, the specific processed portions of the first workpiece and the second workpiece corresponding to each other can be readily set.

The waveform related to the first load current is such that, as indicated by the dashed line in FIG. 4, an absolute value of the load current at corner 13 is lower than an absolute value of the load current at a corresponding portion of the waveform related to the second load current. In other words, at corner 13, the first difference occurs between the first load current and the second load current. When the first difference is higher than or equal to the first threshold value, it can be determined that fracture has occurred in tool 2. The reason that the absolute value of the first load current is lower than the absolute value of the second load current as shown in FIG. 4 may be that the processing resistance of tool 2 decreased, causing a decrease in the load torque of motor 3. The reason that the processing resistance of tool 2 decreased may be that fracture had occurred in tool 2, causing an increased area of tool 2 to be out of contact with workpiece 10. At corner 13, since the edge portion of tool 2 simultaneously acts both on wall surface 11 and bottom surface 12 as described above, a change in the load current of motor 3 becomes noticeable.

It is understood from the above that the occurrence of fracture in tool 2 is determined by obtaining the first difference between the first load current and the second load current, and comparing the first difference with the first threshold value. Specifically, when the absolute value of the first load current becomes lower than the absolute value of the second load current as shown in FIG. 4, it is determined that fracture has occurred in tool 2.

By subjecting the graph shown in FIG. 4 to Fourier transform, Fourier spectra each having a bell-shaped waveform with a peak around 30 Hz are provided, as shown in FIG. 5. The rotational speed of motor 3 and the frequency of the load current are proportional to each other. The unit of the rotational speed of motor 3 is rpm. The frequency of the peak of each Fourier spectrum changes with the rotational speed of motor 3. The frequency of the peak of each Fourier spectrum is this example is illustrative. The rotational speed of motor 3 is determined in consideration of surface roughness of a processed surface of workpiece 10, and a cycle time. In a lower frequency region with respect to the peak of the Fourier spectrum of regions located on opposite tails of the peak, the waveform in the first workpiece has a smaller amplitude than the waveform in the second workpiece. In other words, in the aforementioned region, the first difference occurs between the amplitude in the first workpiece and the amplitude in the second workpiece. When the first difference is higher than or equal to the first threshold value, it can be determined that fracture has occurred in tool 2.

The reason that the amplitude in the first workpiece becomes smaller than the amplitude in the second workpiece in the aforementioned region as shown in FIG. 5 may be that the processing resistance of tool 2 decreased, causing a decrease in the load torque of motor 3, thus not causing a decrease in the rotational speed of motor 3. The reason that the processing resistance of tool 2 decreased may be that fracture had occurred in tool 2, causing an increased area of tool 2 to be out of contact with workpiece 10.

<<Example where Chipping was Detected>>

The waveform related to the second load current obtained when chipping or fracture has not occurred in tool 2 is such that, as indicated by the solid line in FIG. 6, an absolute value of the load current of motor 3 during processing of corner 13 is higher by a prescribed amount than an absolute value of the load current of motor 3 during processing of wall surface 11 or bottom surface 12. Although there is a small error of measurement, the waveform related to the second load current shown in FIG. 6 and the waveform related to the second load current shown in FIG. 4 can be considered substantially the same. For the sake of clarity, the waveform related to the first load current and the waveform related to the second load current are captured at shifted times in FIG. 6. In this case, the comparison between the first load current and the second load current is still possible by focusing on the particular change in each waveform.

The waveform related to the first load current is such that, as indicated by the dashed line in FIG. 6, an absolute value of the load current at corner 13 is higher than an absolute value of the load current at a corresponding portion of the waveform related to the second load current. In other words, at corner 13, the first difference occurs between the first load current and the second load current. When the first difference is higher than or equal to the first threshold value, it can be determined that chipping has occurred in tool 2. The reason that the absolute value of the first load current is higher than the absolute value of the second load current as shown in FIG. 6 may be that the processing resistance of tool 2 increased, causing an increase in the load torque of motor 3. The reason that the processing resistance of tool 2 increased may be that chipping had occurred in tool 2, and a chipped portion of tool 2 had come into contact with workpiece 10. At corner 13, since the edge portion of tool 2 simultaneously acts both on wall surface 11 and bottom surface 12 as described above, a change in the load current of motor 3 becomes noticeable.

It is understood from the above that the occurrence of chipping in tool 2 is determined by obtaining the first difference between the first load current and the second load current, and comparing the first difference with the first threshold value. Specifically, when the absolute value of the first load current becomes higher than the absolute value of the second load current as shown in FIG. 6, it is determined that chipping has occurred in tool 2.

By subjecting the graph shown in FIG. 6 to Fourier transform, Fourier spectra each having a bell-shaped waveform with a peak around 30 Hz are provided, as shown in FIG. 7. The frequency of the peak of each Fourier spectrum is this example is illustrative. In a lower frequency region with respect to the peak of the Fourier spectrum of regions located on opposite tails of the peak, the waveform in the first workpiece has a greater amplitude than the waveform in the second workpiece. In other words, in the aforementioned region, the first difference occurs between the amplitude in the first workpiece and the amplitude in the second workpiece. When the first difference is higher than or equal to the first threshold value, it can be determined that chipping has occurred in tool 2. The reason that the amplitude in the first workpiece becomes greater than the amplitude in the second workpiece in the aforementioned region as shown in FIG. 7 may be that the processing resistance of tool 2 increased, causing an increase in the load torque of motor 3, thus causing a decrease in the rotational speed of motor 3. The reason that the processing resistance of tool 2 increased may be that chipping had occurred in tool 2, and a chipped portion of tool 2 had come into contact with workpiece 10.

<<As to Detection of Chipping or Fracture>>

When the first load current becomes smaller than the second load current in the current waveforms as shown in FIG. 4, it is determined that fracture has occurred in tool 2. When the first load current becomes greater than the second load current in the current waveforms as shown in FIG. 6, it is determined that chipping has occurred in tool 2. In other words, a determination of whether the first load current is smaller or greater than the second load current even allows for a determination of whether damage that has occurred in tool 2 is chipping or fracture.

Similarly, when the amplitude in the first workpiece becomes smaller than the amplitude in the second workpiece in the lower frequency region with respect to the peak of the Fourier spectrum as shown in FIG. 5, it is determined that fracture has occurred in tool 2. When the amplitude in the first workpiece becomes greater than the amplitude in the second workpiece in the lower frequency region with respect to the peak of the Fourier spectrum as shown in FIG. 7, it is determined that chipping has occurred in tool 2. In other words, a determination of whether the amplitude in the first workpiece is smaller or greater than the amplitude in the second workpiece even allows for a determination of whether damage that has occurred in tool 2 is chipping or fracture.

Therefore, when calculating the first difference in aforementioned first calculation unit 511, the magnitude relationship between the first electrical quantity and the second electrical quantity may be determined, and when the first difference is higher than or equal to the first threshold value in the first comparison unit, the magnitude relationship may be displayed.

Without the occurrence of chipping or fracture in tool 2, the waveform related to the first load current is substantially the same as the waveform related to the second load current. In other words, without the occurrence of chipping or fracture in tool 2, the first difference between the first load current and the second load current at corner 13 is below the first threshold value. Similarly, without the occurrence of chipping or fracture in tool 2, the Fourier spectrum in the first workpiece is substantially the same as the Fourier spectrum in the second workpiece. In other words, without the occurrence of chipping or fracture in tool 2, the first difference between the amplitude in the first workpiece and the amplitude in the second workpiece is below the first threshold value in the lower frequency region with respect to the peak of the Fourier spectrum.

### Advantageous Effect

Processing system 1A and the method for manufacturing a processed product of the embodiment can detect chipping or fracture of tool 2 based on the first difference between the first electrical quantity and the second electrical quantity. The second electrical quantity is an electrical quantity obtained during processing with a tool free from chipping or fracture. By obtaining the first difference using the second electrical quantity, therefore, the presence or absence of chipping or fracture that may occur in tool 2 is determined. Specifically, when the first difference is below the first threshold value, it is determined that chipping or fracture has not occurred in tool 2. When the first difference is higher than or equal to the first threshold value, on the other hand, it is determined that chipping or fracture has occurred in tool 2, in processing system 1A and the method for manufacturing a processed product described above, the first difference is compared with the first threshold value. Thus, the occurrence of either fracture or chipping in tool 2 can be accurately detected. In processing system 1A and the method for manufacturing a processed product described above, the electrical quantities at the specific processed portions of the first workpiece and the second workpiece corresponding to each other are compared. Thus, even if the electrical quantity changes in a single workpiece 10, chipping or fracture that has occurred in tool 2 can be accurately detected because the electrical quantities at the same specific portions are compared. Processing system 1A and the method for manufacturing a processed product described above are suitably applicable to finishing in which the electrical quantity obtained by measurement unit 4 during the processing varies over a relatively wide range, rather than to coarse processing in which the electrical quantity varies over a relatively narrow range.

In processing system 1A and the method for manufacturing a processed product of the embodiment, when chipping or fracture that has occurred in tool 2 is detected, the rotational speed of motor 3 is set to zero, that is, the driving of motor 3 is stopped. The manufacture of defective products that have not been appropriately processed can thereby be stopped.

Processing system 1A and the method for manufacturing a processed product of the embodiment can detect wear of tool 2 due to age deterioration based on the second difference between the first electrical quantity and the third electrical quantity. The third electrical quantity is an electrical quantity obtained by measurement unit 4 during processing of the third workpiece with anew tool 2. By obtaining the second difference using the third electrical quantity, therefore, the presence or absence of wear that may occur in tool 2 is determined. Specifically, when the second difference is below the second threshold value, it is determined that the wear of tool 2 due to age deterioration is within an acceptable range. When the second difference is higher than or equal to the second threshold value, on the other hand, it is determined that tool 2 is nearing the end of its life. When the second difference is higher than or equal to the second threshold value, therefore, the controlling of the rotational speed of motor 3 can suppress an adverse effect on the processing accuracy. In particular, when the second difference is higher than or equal to the second threshold value, the setting of the rotational speed of motor 3 to zero, that is, the stopping of the driving of motor 3, can stop the manufacture of defective products that have not been appropriately processed.

<Variations>

The following modifications can be made to the embodiment described above.

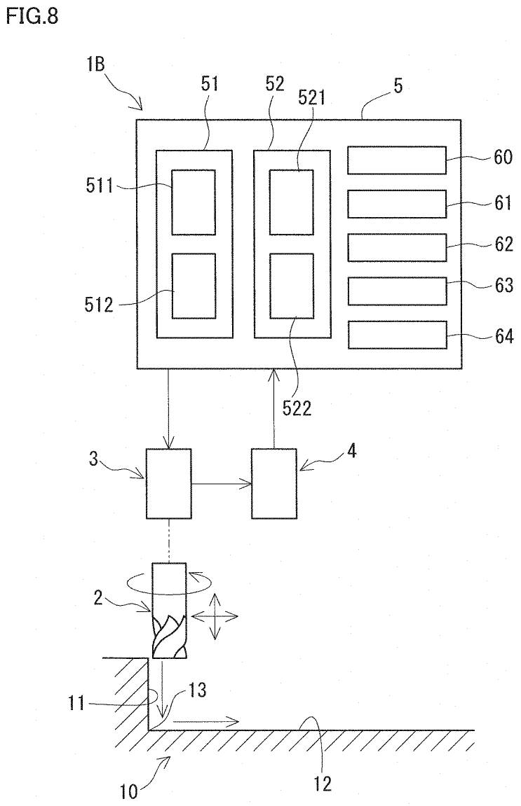

(1) The embodiment above has described an example of turning in which tool 2 is applied to rotating workpiece 10 to perform the turning. Alternatively, as with a processing system 1B shown in FIG. 8, milling in which tool 2 is rotated by motor 3 to perform the milling, without rotation of workpiece 10, is also suitably applicable. In FIG. 8, a chain-double-dotted line connecting tool 2 and motor 3 indicates a virtual axis of rotation of tool 2 rotated by motor 3. Tool 2 rotates about this axis of rotation. Tool 2 of this example is an end mill. Tool 2 is moved vertically and horizontally by motor 3, as indicated by arrows in FIG. 8.

(2) The embodiment above has described an example of performing finishing, in workpiece 10 having the recess, on wall surface 11 and bottom surface 12 in the recess by tool 2. Alternatively, the processing system and the method for manufacturing a processed product described above are also suitably applicable when performing grooving.

(3) The embodiment above has described an example of using an indexable bite as tool 2. Alternatively, tool 2 may be a drill, a side cutter, a T-slot cutter, an end mill, a hob cutter, and the like.

### REFERENCE SIGNS LIST

1A, 1B processing system
2 tool
3, 3A motor
4 measurement unit
5 control unit
51 first control unit, 52 second control unit
511 first calculation unit, 521 second calculation unit
512 first comparison unit, 522 second comparison unit
60 temporary memory
61 first memory, 62 second memory, 63 third memory, 64 fourth memory
10 workpiece
11 wall surface, 12 bottom surface, 13 corner

1. A processing system that successively processes a plurality of workpieces, the processing system comprising:
a tool that processes each of the workpieces;
a motor that rotates the tool or each of the workpieces;
a control unit that controls the motor; and
a measurement unit that obtains an electrical quantity of the motor, wherein
the control unit includes a first control unit that controls a rotational speed of the motor based on a first difference between a first electrical quantity and a second electrical quantity,
the first electrical quantity is an electrical quantity obtained by the measurement unit at a specific processed portion of a first workpiece currently being processed,
the second electrical quantity is an electrical quantity obtained by the measurement unit during processing of a portion of a second workpiece corresponding to the specific processed portion, and
the second workpiece is a workpiece that was processed prior to the first workpiece.

2. The processing system according to claim 1, wherein
the specific processed portion is a portion where a processing condition of the tool changes.

3. The processing system according to claim 1, wherein
the electrical quantity is a load current of the motor.

4. The processing system according to claim 1, wherein
under a condition the first difference is higher than or equal to a prescribed threshold value, the first control unit sets the rotational speed of the motor to zero.

5. The processing system according to claim 1, wherein
the control unit includes a second control unit that controls the rotational speed of the motor based on a second difference between the first electrical quantity and a third electrical quantity,
the third electrical quantity is an electrical quantity obtained by the measurement unit during processing of a portion of a third workpiece corresponding to the specific processed portion, and
the third workpiece is a workpiece that was processed prior to the first workpiece with a new tool.

6. (canceled)

7. The processing system according to claim 2, wherein
the electrical quantity is a load current of the motor.

8. The processing system according to claim 2, wherein
under a condition the first difference is higher than or equal to a prescribed threshold value, the first control unit sets the rotational speed of the motor to zero.

9. The processing system according to claim 3, wherein
under a condition the first difference is higher than or equal to a prescribed threshold value, the first control unit sets the rotational speed of the motor to zero.

10. The processing system according to claim 2, wherein
the control unit includes a second control unit that controls the rotational speed of the motor based on a second difference between the first electrical quantity and a third electrical quantity,
the third electrical quantity is an electrical quantity obtained by the measurement unit during processing of a portion of a third workpiece corresponding to the specific processed portion, and
the third workpiece is a workpiece that was processed prior to the first workpiece with a new tool.

11. The processing system according to claim 3, wherein
the control unit includes a second control unit that controls the rotational speed of the motor based on a second difference between the first electrical quantity and a third electrical quantity,
the third electrical quantity is an electrical quantity obtained by the measurement unit during processing of a portion of a third workpiece corresponding to the specific processed portion, and
the third workpiece is a workpiece that was processed prior to the first workpiece with a new tool.

12. The processing system according to claim 4, wherein
the control unit includes a second control unit that controls the rotational speed of the motor based on a second difference between the first electrical quantity and a third electrical quantity,
the third electrical quantity is an electrical quantity obtained by the measurement unit during processing of a portion of a third workpiece corresponding to the specific processed portion, and
the third workpiece is a workpiece that was processed prior to the first workpiece with a new tool.

13. A method for manufacturing a processed product, in which a plurality of workpieces are successively processed with a tool, the method comprising:
processing each of the workpieces while rotating the tool or each of the workpieces by a motor, and while measuring an electrical quantity of the motor by a measurement unit;
obtaining a first difference between a first electrical quantity and a second electrical quantity; and
controlling a rotational speed of the motor based on the first difference, wherein
the first electrical quantity is an electrical quantity obtained by the measurement unit at a specific processed portion of a first workpiece currently being processed,
the second electrical quantity is an electrical quantity obtained by the measurement unit during processing of a portion of a second workpiece corresponding to the specific processed portion, and
the second workpiece is a workpiece that was processed prior to the first workpiece.

14. The method according to claim 13, wherein
the specific processed portion is a portion where a processing condition of the tool changes.

15. The method according to claim 13, wherein
the electrical quantity is a load current of the motor.

16. The method according to claim 14, wherein
the electrical quantity is a load current of the motor.

17. The method according to claim 13, wherein
under a condition the first difference is higher than or equal to a prescribed threshold value, a controller sets the rotational speed of the motor to zero.

18. The method according to claim 14, wherein
under a condition the first difference is higher than or equal to a prescribed threshold value, a controller sets the rotational speed of the motor to zero.

19. The method according to claim 15, wherein
under a condition the first difference is higher than or equal to a prescribed threshold value, a controller sets the rotational speed of the motor to zero.

20. The method according to claim 16, wherein
under a condition the first difference is higher than or equal to a prescribed threshold value, setting the rotational speed of the motor to zero.

21. The method according to claim 13, wherein
the controlling includes controlling the rotational speed of the motor based on a second difference between the first electrical quantity and a third electrical quantity,
the third electrical quantity is an electrical quantity obtained by the measurement unit during processing of a portion of a third workpiece corresponding to the specific processed portion, and
the third workpiece is a workpiece that was processed prior to the first workpiece with a new tool.
